(19) United States
(12) Patent Application Publication
(10) Pub. No.: US 2010/0307506 A1
(43) Pub. Date: Dec. 9, 2010

(54) MASK BODY FOR A RESPIRATORY HALF-MASK

(76) Inventors: Detlef Kielow, Berlin (DE); Michael Horn, Berlin (DE); Klaus Schmidtke, Berlin (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/742,696

(22) PCT Filed: Oct. 15, 2008
(86) PCT No.: PCT/EP2008/063905

§ 371 Date: Aug. 25, 2010

(30) Foreign Application Priority Data
Nov. 16, 2007 (DE) 10 2007 055 241.8

(51) Int. Cl. A62B 18/10

(52) U.S. Cl. 128/207.12

(57) ABSTRACT

The invention relates to a mask body for a respiratory half-mask, having a substantially rigid installation plate (4) incorporated into the soft elastic material of the mask body (1) and comprising a fastening cylinder (8) integrally molded thereto, having latching tabs (9) and pivot-proof projections (10) for the production of a stable, removable plug-in connection to a holding device that is connected to a strap. The connection of the installation plate to the mask body material is carried out by means of a narrow connecting strip (12) that is integrally molded to the circumference of the installation plate in one piece, having cutouts (7) provided therein, which are interspersed by the mask body material surrounding the connecting strip (12) such that the strongly stressed installation plate is incorporated into the mask body material in a form-fitting and bonded manner.

### DESCRIPTION

The invention relates to a mask body for a respiratory half-mask, comprising exhalation valve and filter connection pieces disposed at the front or laterally as well as fastening means for a holding device connected to a strap, wherein the filter connection and exhalation valve pieces each have a stiffening plate made of hard plastic surrounded by the soft elastic material of the mask body.

Respiratory half-masks are worn in front of the face of a user, covering the mouth and the nose and are used for protection from harmful gases, vapour and particles. They consist of a mask body made of soft, elastic material whose edge region following the shape of the face abuts sealingly against the face. Either two laterally disposed filter connection pieces and one frontally disposed exhalation valve piece or two laterally disposed respiratory valve pieces and one frontally disposed filter connection piece are integrated sealingly in the mask body. A holding device, consisting of hard plastic, for a strap which can be braced against the head of the user is fastened detachably to the outer side of the mask body. A mask body consisting of thick material has the necessary stiffness for secure holding of the filter inserts and the holding device but can only adapt inadequately to the respective shape of the face. A mask body made of thin material certainly seals better but can collapse under the action of the filter inserts and the holding device and therefore compromise the safety of the user.

Known from U.S. Pat. No. 5,062,421 is a respiratory mask having a single, large and rigid, insertion piece for supporting the mask body but which is no longer sufficiently flexible.

U.S. Pat. No. 5,592,937 describes a respiratory mask having a mask body made of a soft elastic material in which stiffening plates made of a hard plastic, connected to the filter connection and exhalation valve pieces are incorporated. A hinge consisting of the material of the mask body is formed between the opposing side edges of the centrally disposed stiffening plate and the laterally disposed stiffening plates. The mask body is consequently sufficiently flexible but still stiff enough that it cannot collapse. Openings are provided in the holding device laid around the mask body, which openings correspond with openings formed by the filter connection and exhalation valve pieces in the stiffening plates. The handling of this respiratory mask presents difficulties insofar as frequent attachment and detachment of the holding device on/from the mask body is complex and a secure connection between the mask body material and the stiffening plates is not ensured.

It is therefore the object of the invention to form a mask body made of soft elastic material, provided with stiffening plates, which is robust and easy to handle and has high wearing comfort and a long lifetime.

According to the invention, the object is achieved with a mask body configured according to the features of patent claim 1. Advantageous further developments of the invention are the subject matter of the dependent claims.

The basic idea of the invention consists in incorporating a substantially bending-resistant installation plate in the front region of the mask body consisting of a soft elastic material. The exhalation valve piece or a filter connection piece is incorporated in the installation plate. A fastening cylinder moulded integrally to the installation plate is used to produce a plug-in connection to the holding device connected to a strap. A narrow connecting strip moulded onto the circumferential edge of the installation plate and surrounded by the mask body material is used to produce a connection between the installation plate and the mask body. The installation plate with the fastening cylinder and projections formed thereon for engagement and prevention of rotation ensure a stable connection between the holding device and the mask body which can be made or released simply and rapidly. According to a further important feature of the invention, the connection effected by means of the connecting strips between the installation plate and the mask body material is achieved by cutouts formed at the edge of the connecting strip which are interspersed with the mask body material and ensure a form-fitting connection. Such a form-fitting connection can also be provided at the laterally disposed stiffening plates in which exhalation valve or filter connection pieces are integrated.

The mask body configured according to the invention provides for a stable simple fastening of the holding device for the strap and ensures a long lifetime and high wearing comfort.

In a further embodiment of the invention, the soft elastic part of the mask body consists of a liquid silicone containing special adhesion promoters so that, in addition to the form-fitting connection, an improved adhesive connection is achieved with the stiffening plates consisting of hard plastic, in particular polyamide or polybutylene terephthalate, and the connecting strip.

In one embodiment of the invention, the fastening cylinder surrounds the exhalation valve piece. The fastening cylinder can also be provided with an internal thread and at the same time serve as a filter connection piece.

The lower edge of the stiffening plates, but at least the connecting strip moulded onto the installation plate, is so far removed from the edge of the mask body that a user can move his lower jaw when the mask is on.

An exemplary embodiment of the invention is explained in detail with reference to the drawing:

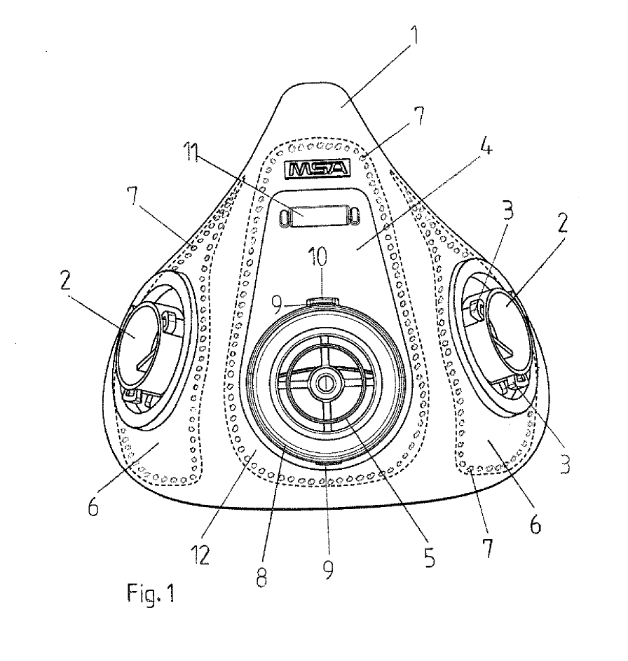

FIG. 1 shows a front view of a mask body for a respiratory half-mask having a frontally disposed exhalation valve piece and two laterally disposed filter connection pieces; and

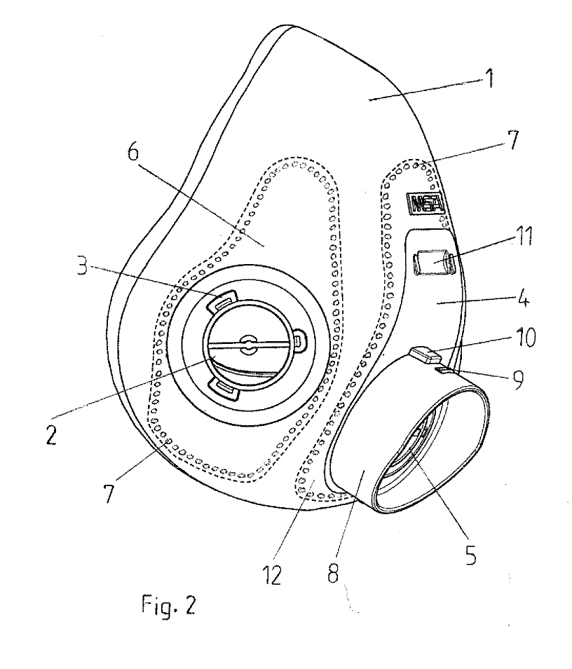

FIG. 2 shows a perspective view of the mask body from FIG. 1.

The mask body 1 shown in the drawing consists of silicone (liquid silicone) which contains special adhesion promoters for chemical bonding with polyamide or polybutylene terephthalate. The mask body 1 has two laterally disposed filter connection pieces 2 with bayonet connectors 3 and a centrally disposed exhalation valve piece 5 integrated in an installation plate 4. A stiffening plate 6 consisting of a hard plastic, i.e. polyamide or polybutylene terephthalate, or—with reference to the installation plate—a connecting strip 12 is integrally connected in each case to the filter connection pieces 2 and the installation plate 4.

The stiffening plates 6 and the connecting strip 12 are completely encased with the silicone of the mask body 1. Cutouts 7 interspersed with silicone are formed in the edge region of the connecting strip 12 and the stiffening plates so that the silicone layers on both sides of the stiffening plates 6 or the connecting strip 12 are connected by webs located in the cutouts 7 and the silicone is held in a form-fitting manner in the stiffening plates 6 or the connecting strip 12. The adhesion promoters contained in the liquid silicone furthermore ensure an additional adhesive connection with the stiffening plates 6 and the connecting strip 12.

The stiffening plates 6 extend in part close to the edge of the mask body and ensure a sufficient stiffness and nevertheless a flexibility of the mask body 1 which satisfies the sealing requirements in the edge zone in order to ensure an adequate sealing on the face. However, the connecting strip 12 moulded onto the installation plate 4 has a greater distance from the lower edge of the mask body 1 in order to allow the user sufficient movement of the lower jaw when wearing the respiratory mask.

The installation plate 4 is used for simple and secure detachable fastening of a holding device connected to a strap (in each case not shown) which holds the mask body 1, on the face or temporarily in a hanging-down position remote from the face, the mask body being comparatively heavy in conjunction with the filter inserts (not shown) and exposed to considerable stresses during usage.

A fastening cylinder 8 having upper and lower latching tabs 9 and a pivot-proof projection 10, is moulded integrally onto the installation plate 4 into which the exhalation valve piece 5 is integrated. A pivot-proof groove 11 is formed at the upper end of the installation plate 4. A holding device adapted to the installation plate 4 thus formed can consequently be plugged quickly onto the installation plate 4 and released therefrom. The fastening cylinder 8 ensures a reliable plug-in connection and transmission of force between the mask body 1 and the holding device.

### REFERENCE LIST

1 Mask body

2 Filter connection piece

3 Bayonet connector

4 Installation plate

5 Exhalation valve piece

6 Stiffening plates

7 Cutouts

8 Fastening cylinder

9 Latching tabs

10 Pivot-proof projection

11 Pivot-proof groove

12 Connecting strip

1. A mask body for a respiratory half-mask, comprising exhalation valve and filter connection pieces (2, 5) disposed at the front or laterally as well as fastening means for a holding device connected to a strap, wherein the filter connection and exhalation valve pieces (2, 5) each have a stiffening plate (6) made of hard plastic surrounded by the soft elastic material of the mask body (1), characterised in that the front-side exhalation valve or filter connection piece (2, 5) is integrated into an installation plate (4) with a thin connecting strip (12) adjoining the edge thereof and a fastening cylinder (8) having latching tabs (9) and a pivot-proof projection (10) for the plug-in connection to the holding device is moulded onto the installation plate (4).

2. The mask body according to claim 1, characterised in that for the secure incorporation of the connecting strip (12) and the stiffening plate (6) into the mask body material, cutouts (7) are formed at the edge of the connecting strip (12) and the stiffening plate (6), which cutouts are interspersed with the mask body material and connect the mask body material starting from both sides to one another and in a form-fitting manner to the connecting strip (12) and stiffening plates (6).

3. The mask body according to claim 2, characterised in that the stiffening plates (6) consist of polyamide or polybutylene terephthalate and the mask body material is a liquid silicone with adhesion promoters to improve the adhesive connection to the connecting strip (12) and the stiffening plates (6).

4. The mask body according to claim 1, characterised in that a pivot-proof groove (11) for fixing the upper part of the holding device is moulded into the outer surface of the installation plate (4).

5. The mask body according to claim 1, characterised in that the lower edge of the connecting strip (12) connected to the installation plate (4) and the stiffening plates (6) end at a distance remote from the mask body edge which still allows the user sufficient under-jaw mobility.

6. The mask body according to claim 1, characterised in that the fastening cylinder (8) surrounds the exhalation valve piece (5).

7. The mask body according to claim 1, characterised in that the fastening cylinder (8) has an internal thread and functions as a filter connecting piece.
